(19) United States
(12) Patent Application Publication
(10) Pub. No.: US 2009/0040158 A1
(43) Pub. Date: Feb. 12, 2009

(54) GAMMA REFERENCE VOLTAGE GENERATING DEVICE, METHOD FOR GENERATING GAMMA REFERENCE VOTLAGE, AND GRAY LEVEL VOLTAGE GENERATING DEVICE

(75) Inventor: Chih-Chiang Chuang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/930,119

(22) Filed: Oct. 31, 2007

(30) Foreign Application Priority Data
Aug. 10, 2007 (TW) 96129605

(51) Int. Cl. G09G 3/36

(52) U.S. Cl. 345/89; 345/87

(57) ABSTRACT

A gamma reference voltage generating device, a method for generating gamma reference voltages, and a gray level voltage generating device are provided. The gray level voltage generating device includes a selection unit and a gray level voltage generator. The selection unit is adapted for receiving M first gamma reference voltages, and selecting N second gamma reference voltages from the M first gamma reference voltages and outputting the N second gamma reference voltages, wherein M and N are positive integers, and M>N. The gray level voltage generator is coupled to the selection unit, for generating a plurality of gray level voltages according to the N second gamma reference voltages. The gamma curve can be adaptively adjusted by using the present invention so as to improve the display quality.

### CROSS-REFERENCE TO RELATED APPLICATION

This application claims the priority benefit of Taiwan application serial no. 96129605, filed on Aug. 10, 2007. All disclosure of the Taiwan application is incorporated herein by reference.

### BACKGROUND OF THE INVENTION

1. Field of the Invention

The present invention generally relates to voltage generating devices and method for displays, and more particularly, to a gray level voltage generating device and a gamma reference voltage generating device.

2. Description of Related Art

Being boosted by the development of semiconductor components and human-machine display devices, multi-media technology is being advanced drastically. As for displays, cathode ray tube (CRT) displays having advantages of great display quality and low production cost, monopolized the display market for quite a long time. However, CRT displays also have many disadvantages, such as bulky volume and high radiation. Therefore, liquid crystal displays (LCDs) having the great advantages of higher display quality, more space-saving, lower power consumption, non-radiation relative to the CRT displays, have gradually become the mainstream of the market. Driving modes of the LCDs are to be further discussed hereinafter.

FIG. 1 is a schematic diagram of a conventional LCD, and FIGS. 2A and 2B are schematic circuit diagrams of a gamma reference voltage source and a source driver of FIG. 1. Referring to FIGS. 1, 2A and 2B, the conventional LCD 100 employs a gamma reference voltage source 110 to provide gamma reference voltages V_{GMA}_{_{—}}₁ through V_{GMA}_{_{—}}_{N} to a source driver 120. As shown in FIG. 2A, the gamma reference voltage source 110 is coupled to a system voltage AVDD, and serially connects a plurality of resistors 112 together. The gamma reference voltage source 110 generates the gamma reference voltages V_{GMA}_{_{—}}₁ through V_{GMA}_{_{—}}_{N} by voltage dividing and provides the same to a gray level voltage generating device 122. Furthermore, as shown in FIG. 2B, a gamma reference voltage source 114 can be employed to substitute the gamma reference voltage source 110 of FIG. 2A. The gamma reference voltage source 114 obtains the gamma reference voltages V_{GMA}_{_{—}}₁ through V_{GMA}_{_{—}}_{N} by employing a plurality of resistors 116 of different resistances.

Further, as shown in FIGS. 1 and 2A, the gray level voltage generating device 122 correspondingly generates a plurality of gray level voltages V_{g1} through V_{gn} according to the gamma reference voltages V_{GMA}_{_{—}}₁ through V_{GMA}_{_{—}}_{N}. Then, the source driver 120 and a gate driver 130 drive pixel units 142 of a display panel 140 via a plurality of source driving lines S₁ through Sᵢ and a plurality of gate driving lines G₁ through Gⱼ.

FIG. 3 is a curve illustrating a corresponding relationship between the gray level input data and the gamma output voltage of FIG. 1. Referring to FIGS. 1 and 3 together, a digital-analog-converter (DAC) (not shown) of the source driver 120 correspondingly generates gamma output voltages according to gray level input data received thereby. When the gray level input data is G_{Ln}, the DAC (not shown) generates a gamma output voltage Vₙ. Likewise, when the gray level input data is G_{Lm}, the DAC (not shown) generates a gamma output voltage Vₘ. The range of Vₙ through Vₘ corresponds to the range of G_{Ln} through G_{Lm}. The relative curve of the gray level input data and the gamma output voltages is the so called gamma curve 150, according to which the LCD 100 can correctly display luminance.

However, the gamma curve 150 of the LCD 100 is usually set before leaving factory. In other words, the conventional LCD 100 cannot adjust the gamma curve 150 in accordance with different environments.

Accordingly, U.S. Patent Application No. US2007/0085792A1 proposes to employ a plurality of additional voltage sources into the gamma reference voltage source, so as to allow the gamma reference voltages generated by the serially connected resistors of the gamma reference voltage source to shift. Unfortunately, this requires adding more voltage sources as well as production cost. Further, this can shift all of the gamma reference voltages as a whole, but cannot change the shape of the gamma curve, thus can do little to adjust the gamma curve.

Moreover, U.S. Patent Application No. 2007/0046600A1 proposes to employ a selection controller for coupling a same set of voltage sources to one of a plurality of sets of serially connected resistors. The plurality of sets of serially connected resistors are different in resistance ratio from one to another, different gamma curves can be generated. However, this method requires too many sets of serially connected resistors. This not only demands too much additional cost, but also requires much more additional circuit area. Further, one set of serially connected resistors can generate one gamma curve only. In other words, when there are only three sets of serially connected resistors equipped for the display, it must be switched among three correspondingly gamma curves. Therefore, the adjustment of the gamma curve is also restricted.

### SUMMARY OF THE INVENTION

The present invention is directed to a gray level voltage generating device which is adapted for correctly corresponding digital gray level data to the gray level voltages.

The present invention is also directed to a gamma reference voltage generating device and a method for generating gamma reference voltages, by which a gamma curve can be elastically adjusted, and adapted to improve display quality.

The present invention provides a gray level voltage generating device, adapted for a display device which can display a plurality of gray levels. The gray level voltage generating device includes a selection unit and a gray level voltage generator. The selection unit is adapted for receiving M first gamma reference voltages, and selecting N second gamma reference voltages from the M first gamma reference voltages and outputting the N second gamma reference voltages, wherein M and N are positive integers, and M>N. The gray level voltage generator is coupled to the selection unit for generating a plurality of gray level voltages according to the N second gamma reference voltages. The display device displays the gray levels according to the gray level voltages.

According to an embodiment of the present invention, the selection unit includes N switches, defined respectively in sequence as first switch, second switch, and N^{th} switch. Each of the switches includes P input ends, at least one control end, and at least one output end. The P input ends are numbered in sequence as first input end, second input end, . . . , P^{th} input end. The control ends of the switches receive a switching signal. Each of the switches respectively selects one of the input ends to output to the output end according to the switching signal, wherein P is positive integer.

According to an embodiment of the present invention, the gray level voltage generator further includes a voltage dividing resistor unit coupled to a voltage source. The voltage dividing resistor unit includes a plurality of voltage dividing points for providing the foregoing first gamma reference voltages respectively. According to another embodiment of the present invention, the voltage dividing resistor unit further includes a serially connected resistor unit coupled to the voltage source so as to provide the foregoing first gamma reference voltages. According to still another embodiment of the present invention, the voltage dividing resistor unit further includes a plurality of serially connected resistor units parallel connected to the voltage source so as to provide the foregoing first gamma reference voltages. The first gamma reference voltages are different from one another.

The present invention also provides a gamma reference voltage generating device coupled to a source driver. The gamma reference voltage generating device includes a gamma reference voltage source and a selection unit. The gamma reference voltage source is adapted for providing M first gamma reference voltages. The selection unit is coupled to the gamma reference voltage source, for selecting N second gamma reference voltages from the M first gamma reference voltages and outputting the N second gamma reference voltages to the source driver, wherein M, N are positive integers, and M>N.

The present invention further provides a gamma reference voltage generating device. The gamma reference voltage generating device includes a voltage dividing resistor unit and a selection unit. The voltage dividing resistor unit is coupled to a voltage source. The voltage dividing resistor unit includes a first voltage dividing point and a second voltage dividing point for providing a first gamma reference voltage and a second gamma reference voltage respectively. The selection unit includes a first switch. The first switch is coupled to the first voltage dividing point and the second voltage dividing point. The first switch receives the first gamma reference voltage and the second gamma reference voltage respectively, and selects one from the received first gamma reference voltage and second gamma reference voltage to output according to a selection signal.

According to an embodiment of the present invention, the voltage dividing unit further includes a third voltage dividing point for providing a third gamma reference voltage. According to another embodiment, the first switch is coupled to the third voltage dividing point for receiving the third gamma reference voltage. According to another embodiment of the present invention, the selection unit further includes a second switch, coupled to the second voltage dividing point and the third voltage dividing point, for receiving the second gamma reference voltage and the third gamma reference voltage, respectively, and selecting one from the gamma reference voltages received by the second switch to output according to the selection signal.

According to an embodiment of the present invention, when the first switch outputs the first gamma reference voltage, the second switch outputs the second gamma reference voltage, and when the first switch outputs the second gamma reference voltage, the second switch outputs the third gamma reference voltage.

According to an embodiment of the present invention, the voltage dividing resistor unit further includes a fourth voltage dividing point for providing a fourth gamma reference voltage. According to another embodiment of the present invention, the selection unit further includes a third switch. The third switch is coupled to the third voltage dividing point and the fourth voltage dividing point for receiving the third gamma reference voltage and the fourth gamma reference voltage respectively, and selecting one from the gamma reference voltages received by the third switch to output according to a selection signal.

According to an embodiment of the present invention, the first switch is coupled to the third voltage dividing point for receiving the third gamma reference voltage. According to another embodiment, the selection unit further includes a fourth switch. The fourth switch is coupled to the second voltage dividing point, the third voltage dividing point, and the fourth voltage dividing point, for receiving the second gamma reference voltage, the third gamma reference voltage, and the fourth gamma reference voltage, respectively, and selecting one from the gamma reference voltages received by the fourth switch to output according to the selection signal. According to another embodiment, when the first switch outputs the first gamma reference voltage, the fourth switch outputs the second gamma reference voltage. When the first switch outputs the second gamma reference voltage, the fourth switch outputs the third gamma reference voltage. When the first switch outputs the third gamma reference voltage, the fourth switch outputs the fourth gamma reference voltage.

The present invention is also directed to a method for generating gamma reference voltages, including receiving M gamma reference voltages, in which M is a positive integer. When a first switch signal is received, N gamma reference voltages are selected from the M gamma reference voltage for configuring a first gamma reference curve, and the N gamma reference voltages are then outputted, wherein N is a positive integer and M>N. When a second switch signal is received, N gamma reference voltages are selected from the M gamma reference voltage to configure a second gamma reference curve, and the N gamma reference voltages are then outputted, wherein the first gamma curve is different from the second gamma curve.

The present invention receives M gamma reference voltages, and then selects N gamma reference voltages from the M gamma reference voltages, wherein M and N are positive integers, and M>N. As the N gamma reference voltages are selected according to different rules, different gamma curves can be obtained. Therefore, the gamma curve can be adaptively adjusted, so as to further improve the display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional LCD.

FIGS. 2A and 2B are schematic circuit diagrams of a gamma reference voltage source and a source driver of FIG. 1.

FIG. 3 is a curve illustrating a relationship between the gray level input data and the gamma output voltage of FIG. 1.

FIG. 4 is schematic diagram illustrating an LCD according to a first embodiment of the present invention.

FIG. 5A is a schematic diagram illustrating a gamma reference voltage generating device and a gray level voltage generating device according to the first embodiment of the present invention.

FIG. 5B is a schematic diagram illustrating principles of three kinds of serially connected resistor units.

FIG. 5C is a schematic diagram illustrating three gamma curves according to the first embodiment of the present invention.

FIG. 6A is a schematic diagram illustrating a gamma reference voltage generating device and a gray level voltage generating device according to a second embodiment of the present invention.

FIG. 6B is a schematic diagram illustrating a gamma reference voltage generating device and a gray level voltage generating device according to a third embodiment of the present invention.

FIG. 6C is a schematic diagram illustrating a gamma reference voltage generating device and a gray level voltage generating device according to a fourth embodiment of the present invention.

FIGS. 7A through 7C are schematic diagrams illustrating a gamma reference voltage generating device and a gray level voltage generating device according to a fifth embodiment of the present invention.

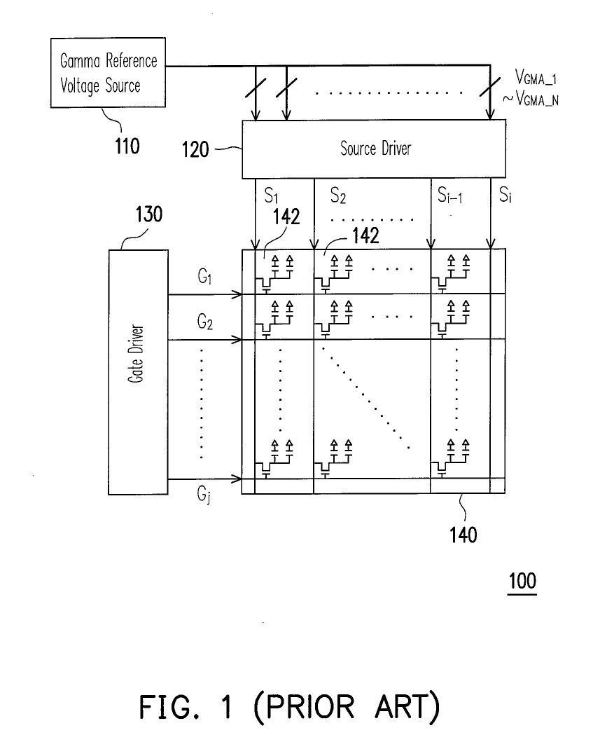

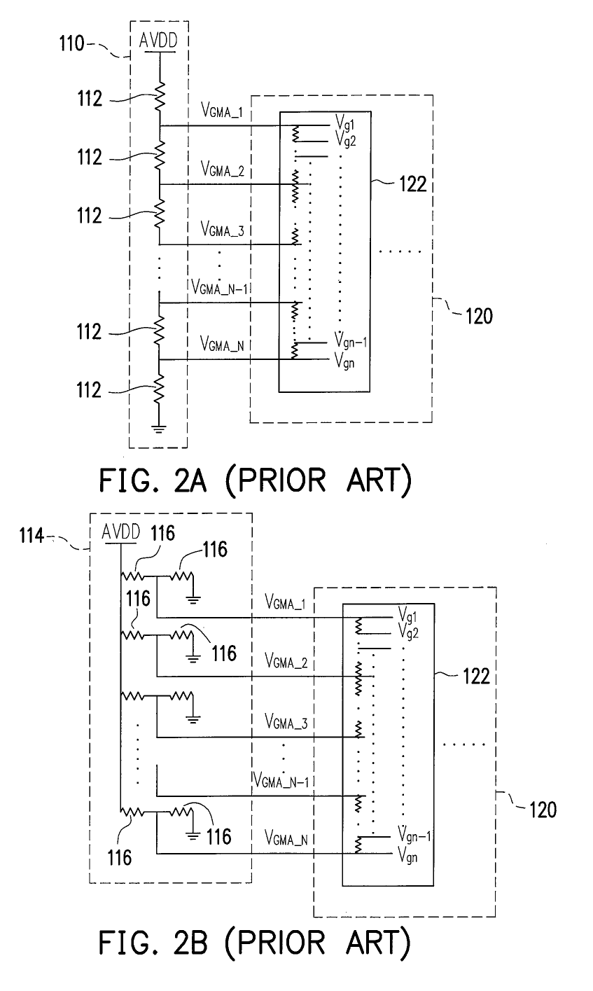

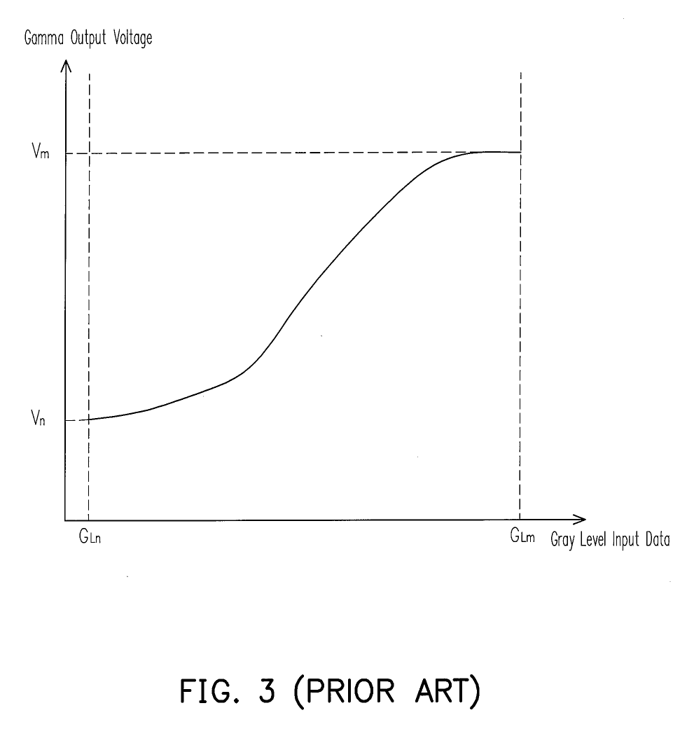

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The conventional technologies are incapable of conveniently adjusting the gamma curves, and require relatively high production costs for hardware. Therefore, the present invention employs a selection unit to receive M gamma reference voltages, and then selects N gamma reference voltages from the M gamma reference voltages, wherein M and N are positive integers, and M>N, so that different gamma curves can be obtained. Therefore, the gamma curve can be adaptively adjusted. An LCD is taken as an example for illustration in details hereinafter.

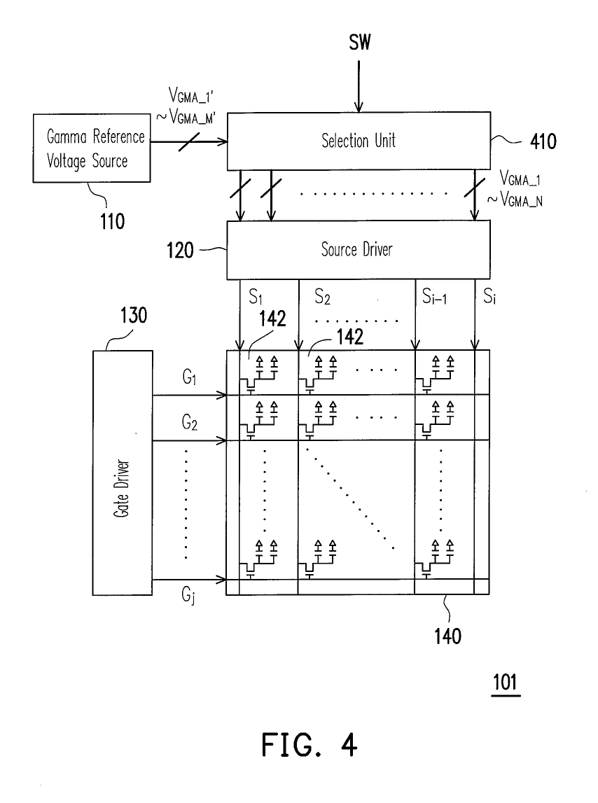

FIG. 4 is schematic diagram illustrating an LCD according to a first embodiment of the present invention. Referring to FIG. 4, the LCD 101 includes a gamma reference voltage source 110, a selection unit 410, a source driver 120, a gate driver 130, and a display panel 140. In the instant embodiment, the gate driver 130 and the display panel 140 are similar with that of conventional technologies, while the gamma reference voltage source 110, the selection unit 410, and the source driver 120 should be paid with more attention. The gamma reference voltage source 110 provides M gamma reference voltages V_{GMA}_{_{—}}_{1′} through V_{GMA}_{_{—}}_{M′}. The selection unit 410 is adapted to select N gamma reference voltages V_{GMA}_{_{—}}₁ through V_{GMA}_{_{—}}_{N} from the M gamma reference voltages V_{GMA}_{_{—}}_{1′} through V_{GMA}_{_{—}}_{M′}. For convenience of illustration, M and N are exemplified as 17 and 8. However, the present invention does not restrict M and N to be 17 and 8. In other embodiments, M and N can be any other positive integers while M>N. The gamma reference voltage source 110, the selection unit 410, and the source driver 120 are to be further illustrated in more details below.

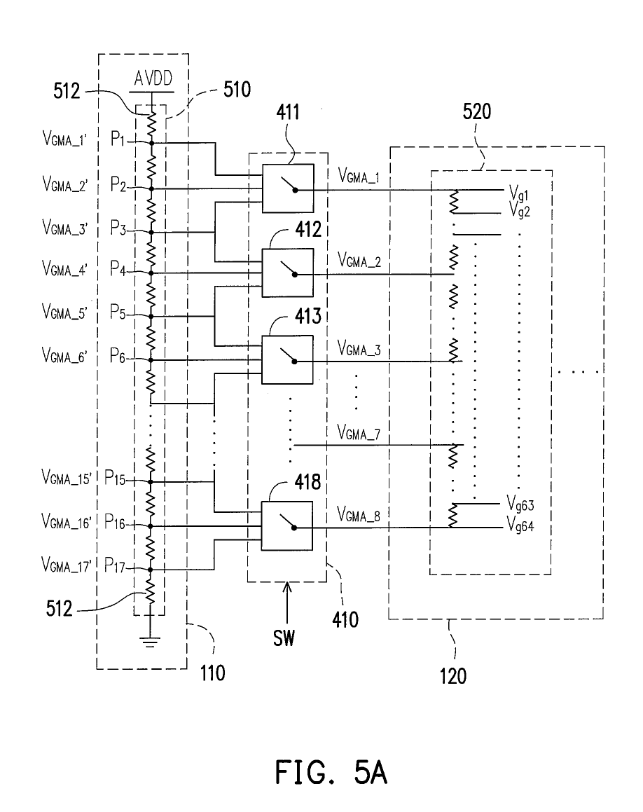

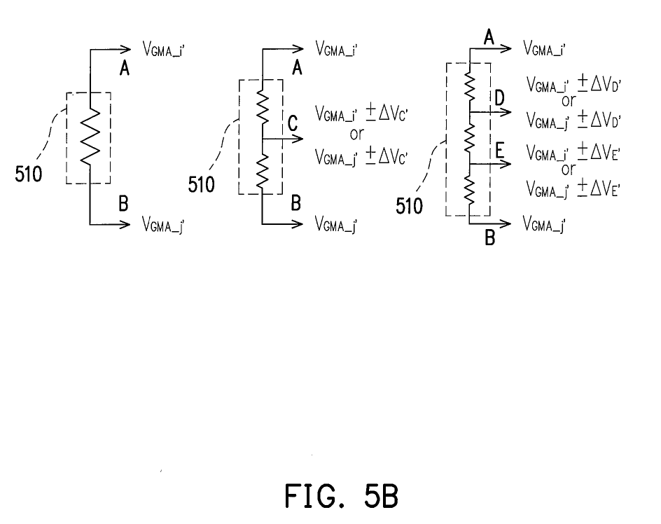

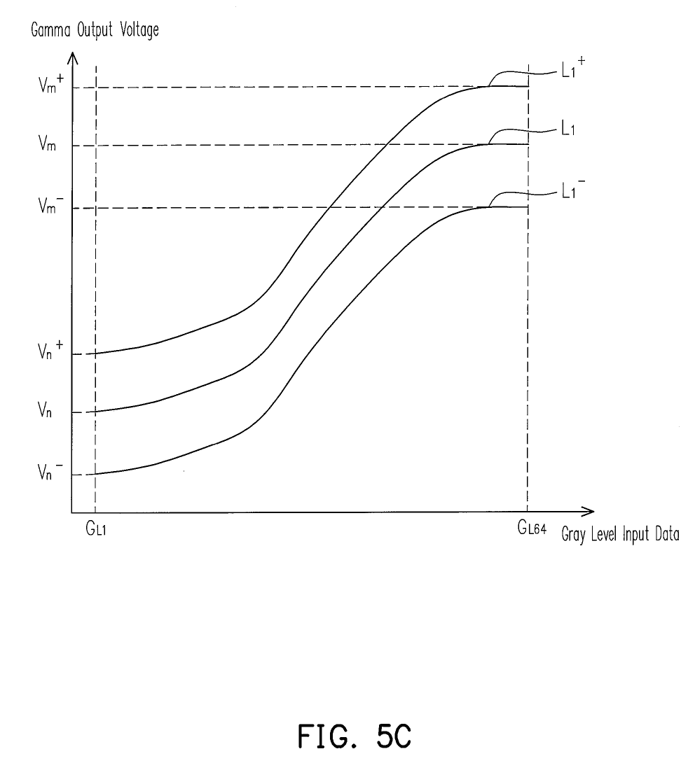

FIG. 5A is a schematic diagram illustrating a gamma reference voltage generating device and a gray level voltage generating device according to the first embodiment of the present invention. Referring to FIG. 5A, there is illustrated a gamma reference voltage generating device includes a gamma reference voltage source 110, and a selection unit 410. Viewing from another angle, there is also shown a gray level voltage generating device including the selection unit 410 and a gray level voltage generating device 520. The gray level voltage generating device 520 for example can be disposed in a source driver 120. The gamma reference voltage source 110 for example can be realized by a voltage dividing resistor unit 510. According to the current embodiment, the voltage dividing resistor unit 510 is composed of 18 serially connected resistors 512, and respectively provides gamma reference voltages gamma reference V_{GMA}_{_{—}}_{1′} through V_{GMA}_{_{—}}_{17′} to the voltage dividing points P1 through P17, wherein the gamma reference voltages V_{GMA}_{_{—}}_{1′} through V_{GMA}_{_{—}}_{17′} are arranged in a descending order.

As shown in FIG. 5A, the voltage dividing resistor unit 510 is a serially connected resistor unit composed of 18 electrically connected resistors 512. However in other embodiments, those of ordinary skill in the art may be taught by the principle of dividing voltage introduced by FIG. 5B to realize the voltage dividing resistor unit 510 with different quantity of resistors and thus providing component voltages of a different quantity. FIG. 5B is a schematic diagram illustrating principles of three kinds of serially connected resistor units. Referring to FIG. 5B, suppose components' voltages at terminals A and B are V_{GMA}_{_{—}}_{i′} and V_{GMA}_{_{—}}_{j′} respectively. When the voltage dividing resistor unit 510 are composed of two serially connected resistors, a voltage at a terminal C as shown in FIG. 5B is V_{GMA}_{_{—}}_{i′}±ΔV_{C′} or V_{GMA}_{_{—}}_{j′}±ΔV_{C′}. Likewise, when the voltage dividing resistor unit 510 is composed of three serially connected resistors, a voltage at a terminal D shown in FIG. 5B is V_{GMA}_{_{—}}_{i′}±ΔV_{D′} or V_{GMA}_{_{—}}_{j′}±ΔV_{D′}, and a voltage at a terminal E shown in FIG. 5B is V_{GMA}_{_{—}}_{i′}±ΔV_{E′} or V_{GMA}_{_{—}}_{j′}±ΔV_{E′}.

Referring back to FIG. 5A, the selection unit 410 for example includes a plurality of switches 411 through 418. According to an aspect of the embodiment, each of the switches 411 through 418 includes 3 input ends, one control end, and an output end. In details, the switch 411 is capable of selecting one from the gamma reference voltages V_{GMA}_{_{—}}_{1′} through V_{GMA}_{_{—}}_{3′} according to a switching signal SW and outputting the one as V_{GMA}_{_{—}}₁. Similarly, the switch 412 can also select one from the gamma reference voltages V_{GMA}_{_{—}}_{3′} through V_{GMA}_{_{—}}_{5′} and output the one as V_{GMA}_{_{—}}₂. Likewise, the switches 413 through 418 have similar capabilities and functions and are not to be iterated hereby. The gray level voltage generating device 520 is adapted to generate gray level voltages, for example V_{g1} through V_{g64}, according to the gamma reference voltages V_{GMA}_{_{—}}₁ through V_{GMA}_{_{—}}₈. The LCD 101 utilizes the gray level voltages V_{g1} through V_{g64} to display gray level data G_{L1} through G_{L64} respectively.

FIG. 5C is a schematic diagram illustrating three gamma curves according to the first embodiment of the present invention. Referring to FIGS. 4, 5A and 5C, the switching signal SW is adapted for controlling control ends selected by the switches 411 through 418. According to an aspect of the embodiment, the switching signal SW synchronously controls the switches 411 through 418 to select input ends of a same number as output ends. Suppose at an initial stage, the switch 411 selects the gamma reference voltage V_{GMA}_{_{—}}_{2′}, the switch 412 selects the gamma reference voltage V_{GMA}_{_{—}}_{4′}, the switch 413 selects the gamma reference voltage V_{GMA}_{_{—}}_{6′}, and similarly the rest switches 414 through 418 select gamma reference voltages respectively, the gamma curve correspondingly is L₁.

When the LCD 101 is affected by the environment or other factors so that the image frame displayed on the display panel 140 becomes darker, the switching signal SW controls the switch 411 to the gamma reference voltage V_{GMA}_{_{—}}_{1′}, and simultaneously the switch 412 is switched to the gamma reference voltage V_{GMA}_{_{—}}_{3′}, the switch 413 is switched to the gamma reference voltage V_{GMA}_{_{—}}_{5′}, . . . , likewise the rest switches 414 through 418 are switched to their corresponding gamma reference voltages, and are not to be iterated hereby. In such a way, the gamma curve is changed from L₁ to L₁⁺. As such, the displayed image frame displayed on the display panel 140 can be adjusted to a normal condition.

According to another aspect of the embodiment, when the LCD 101 is affected by the environment or other factors so that the image frame displayed on the display panel 140 becomes brighter, the switching signal SW controls the switch 411 to the gamma reference voltage V_{GMA}_{_{—}}_{3′}, and simultaneously the switch 412 is switched to the gamma reference voltage V_{GMA}_{_{—}}_{5′}, the switch 413 is switched to the gamma reference voltage V_{GMA}_{_{—}}_{7′}, . . . , likewise the rest switches 414 through 418 are switched to their corresponding gamma reference voltages, and are not to be iterated hereby. In such a way, the gamma curve is changed from L₁ to L₁⁻. As such, the displayed image frame displayed on the display panel 140 can be adjusted to a normal condition. Accordingly, the instant embodiment of the present invention is adapted to utilize the switching signal SW to adjust the displayed image frame to a normal condition when the displayed image frame is found to be darker or brighter than normal.

However, it should be noted that although the embodiment is exemplified in that the switching signal SW synchronously controls the switches 411 through 418 to select input terminals of a same number, it is not intended to restrict the scope of the present invention as such. In other embodiments, a plurality of switching signals can be employed for controlling the switches respectively. For example, switching signals SW1 through SW8 can be employed for controlling the input terminals selected by the switches 411 through 418. In such a way, there are 3⁸ kinds of possible variations of the gamma curve.

Furthermore, although the embodiment illustrates the present invention assuming that each of the switches 411 through 418 includes 3 input ends, those of ordinary skill in the art may be taught by the present invention to change the quantity of the input ends of the switches 411 through 418. For example, each of switches 411 through 418 may includes 5 input ends, thus the corresponding gamma curve has 5⁸ kinds of possible variations. Furthermore, each of the switches 411 through 418 may includes different quantities of input ends. For example, each of the switches 411 through 418 respectively include 2 to 9 input ends. As such, the gamma curve may has 2×3× . . . ×9 kinds of variations.

Furthermore, those of ordinary skill in the art may also vary the quantity of the switches. For example, when the quantity of the employed switches is modified as 64, and each of which includes 3 input ends may be adapted for controlling the switches according to the switching signal. In such a way, there are 3⁶⁴ kinds of possible variations of the gamma curve.

Moreover, those of ordinary skill in the art may also be taught according to the preset invention to employ a part of gamma reference voltages having fixed values, and allow the other gamma reference voltages to be selected. For example, the switches 411 and 412 as shown in FIG. 5A are omitted hereby, and the gamma reference voltage V_{GMA}_{_{—}}_{2′} serves as V_{GMA}_{_{—}}₁, the gamma reference voltage V_{GMA}_{_{—}}_{4′} serves as V_{GMA}_{_{—}}₂. Meanwhile, the two resistors 512 between the system voltage AVDD and the gamma reference voltage V_{GMA}_{_{—}}_{2′} are replaced with a single one, and the two resistors 512 between the gamma reference voltage V_{GMA}_{_{—}}_{2′} and the gamma reference voltage V_{GMA}_{_{—}}_{4′} are replaced with a single one. In such a way, those of ordinary skill in the art can be capable of specifically adjusting a section of the gamma curve, and even saving cost of hardware, i.e., two resistors and two switches. In order to more apparently illustrating the advantages of the present invention, the embodiments of the present invention are compared with conventional technologies in details hereinafter.

According to the conventional technologies introduced above, U.S. Patent Application No. US2007/0085792A1 proposes to employ a plurality of additional system voltage sources into the gamma reference voltage source for adjusting the gamma curve. Unfortunately, this not only requires adding more voltage sources as well as production cost, but also can shift all of the gamma reference voltages as a whole only. Further, U.S. Patent Application No. 2007/0046600A1 proposes to employ a selection controller for coupling a same set of voltage sources to one of a plurality of sets of serially connected resistors. However, this method requires too many sets of serially connected resistors. This not only demands too much additional cost, but also requires much more additional circuit area. Further, one set of serially connected resistors can generate only one gamma curve.

Compared to the conventional, the embodiments according to the present invention can adaptively adjust the gamma curve by employing only one serially connected resistor unit and one selection unit without changing the system voltage AVDD. The gamma curve according to the above embodiment of the present invention has many possible variations. Because system voltage AVDD of the present invention has a fixed value, any voltage deviation may be avoided. Further, it should be noted that the switches of the selection unit can be realized with transistors which are much cheaper and smaller. Accordingly, not only hardware cost is reduced but also the flexibility of adjusting the gamma curve can be improved.

Although the foregoing embodiments have exemplified the gamma reference voltage generating device and the gray level voltage generating device, it would be well known to those of ordinary skill in the art that different manufacturers of LCDs design the gamma reference voltage generating device, the method for generating gamma reference voltages, and the gray level voltage generating device differently. The present invention is not restricted to only those disclosed in the above embodiments. It should be construed that if only there are M gamma reference voltages received, and there are N gamma reference voltages selected from the M gamma reference voltages and outputted, wherein M, N are positive integers and M>N, it is construed to be within the scope of the present invention. More embodiments are described below for more clearly understanding the present invention.

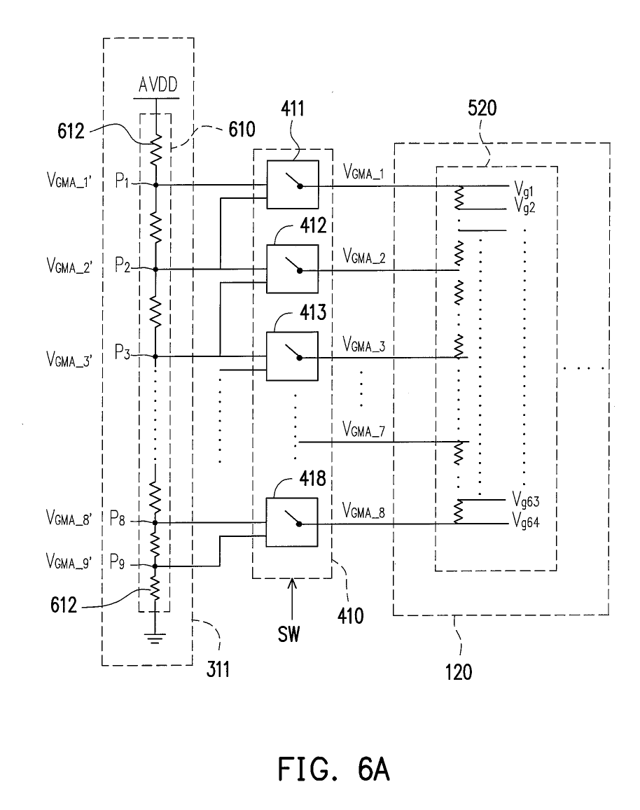

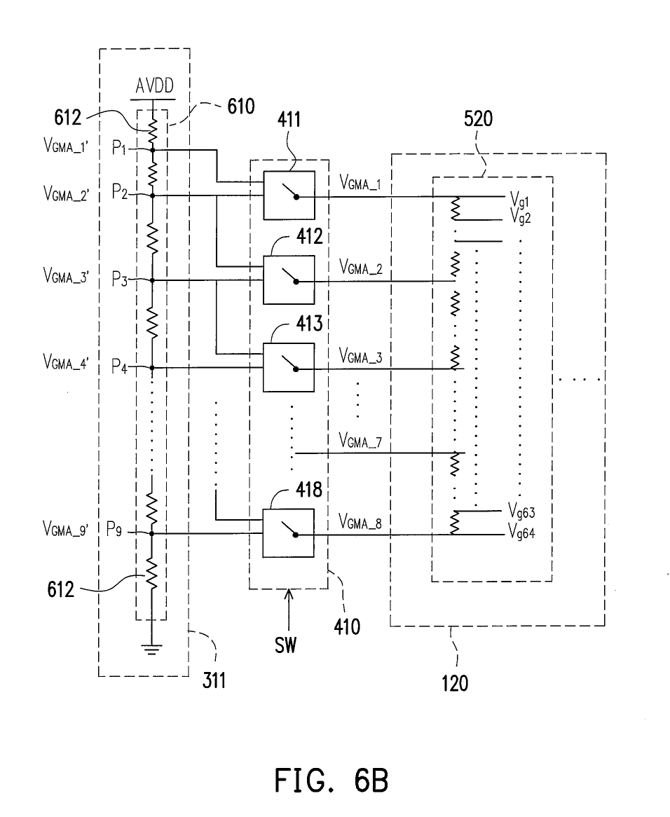

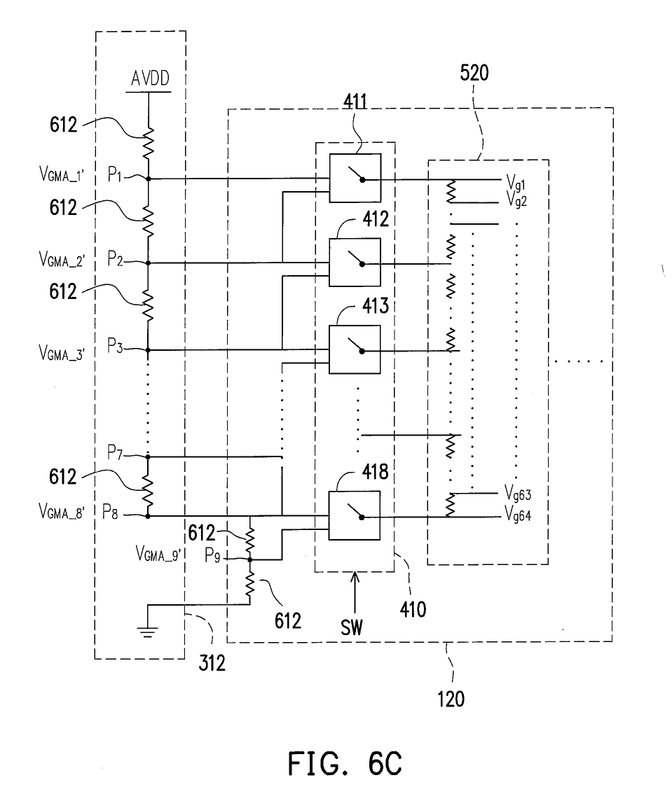

FIG. 6A is a schematic diagram illustrating a gamma reference voltage generating device and a gray level voltage generating device according to a second embodiment of the present invention. Referring to FIGS. 5A and 6A together, the source driver 120 and the selection unit 410 of FIG. 6A are similar to that of FIG. 5A and are not to be iterated hereby. It should be noted that each of the switches 411 through 418 according to the current embodiment respectively includes a first input end and a second input end. The second input end of the first switch 411 and the first input end of the second switch 412 are coupled to a same gamma reference voltage; the second input end of the second switch 412 and the first input end of the third switch 413 are coupled to a same gamma reference voltage; . . . and the rest may be deduced by analogy.

Further, the serially connected resistor unit 610 according to the current embodiment employs 10 resistors 612 only. Assume the switch 411 selects the gamma reference voltage V_{GMA}_{_{—}}_{1′}, the switch 412 selects the gamma reference voltage V_{GMA}_{_{—}}_{2′}, the switch 413 selects the gamma reference voltage V_{GMA}_{_{—}}_{3′}, and similarly the remaining switches 414 through 418 select gamma reference voltages respectively at the initial stage.

When the LCD 101 is affected by the environment or other factors so that the image frame displayed on the display panel 140 becomes brighter, the switching signal SW controls the switch 411 to the gamma reference voltage V_{GMA}_{_{—}}_{2′}, and simultaneously the switch 412 is switched to the gamma reference voltage V_{GMA}_{_{—}}_{3′}, the switch 413 is switched to the gamma reference voltage V_{GMA}_{_{—}}_{4′}, . . . , likewise the rest switches 414 through 418 are switched to their corresponding gamma reference voltages, and are not to be iterated hereby. In such a way, the displayed image frame displayed on the display panel 140 can be adjusted to a normal condition. Further, the present embodiment is capable of not only maintaining the shape of the original gamma curve and simplifying coupling circuit of the switch 412, but also decreases the number of resistors 612.

FIG. 6B is a schematic diagram illustrating a gamma reference voltage generating device and a gray level voltage generating device according to a third embodiment of the present invention. Referring to FIGS. 6A and 6B together, the source driver 120, the selection unit 410, and the gamma reference voltage source 311 are similar to those of FIG. 6A and are not to be iterated hereby. However, it should be noted that the current embodiment supposes that at an initial stage, the switch 411 selects the gamma reference voltage V_{GMA}_{_{—}}_{2′}, the switch 412 selects the gamma reference voltage V_{GMA}_{_{—}}_{3′}, the switch 413 selects the gamma reference voltage V_{GMA}_{_{—}}_{4′}, and the rest switches 414 through 418 select gamma reference voltages can be deduced respectively.

When the LCD 101 is affected by the environment or other factors so that the image frame displayed on the display panel 140 becomes darker, the switching signal SW controls the switch 411 to the gamma reference voltage V_{GMA}_{_{—}}_{1′}, and simultaneously the switch 412 is switched to the gamma reference voltage V_{GMA}_{_{—}}_{2′}, the switch 413 is switched to the gamma reference voltage V_{GMA}_{_{—}}_{3′}, . . . , likewise the remaining switches 414 through 418 are switched to their corresponding gamma reference voltages, and are not to be iterated hereby. In such a way, the displayed image frame displayed on the display panel 140 can be adjusted to a normal condition.

Those of ordinary skill in the art may modify the present invention according to the spirit embodied in the embodiments as disclosed above to vary the structure of the gamma reference voltage generating device and the gray level voltage generating device. FIG. 6C is a schematic diagram illustrating a gamma reference voltage generating device and a gray level voltage generating device according to a fourth embodiment of the present invention. The structure of the fourth embodiment is similar to that of the foregoing embodiments, except for the selection unit 410 is integrated into the source driver 120, and a part of the resistor 612 of the gamma reference voltage source 312 is disposed into the source driver 120. Similar function can also be achieved by the fourth embodiment.

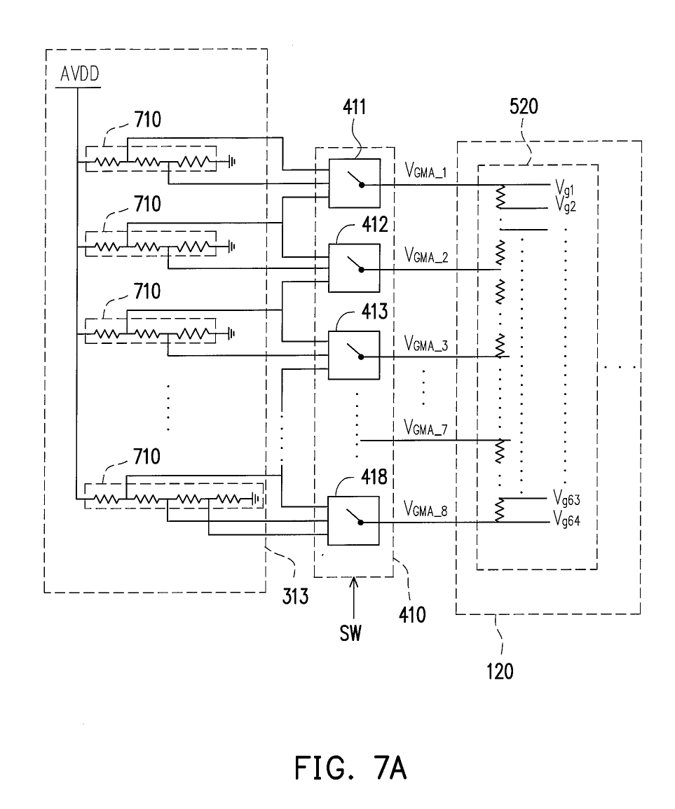

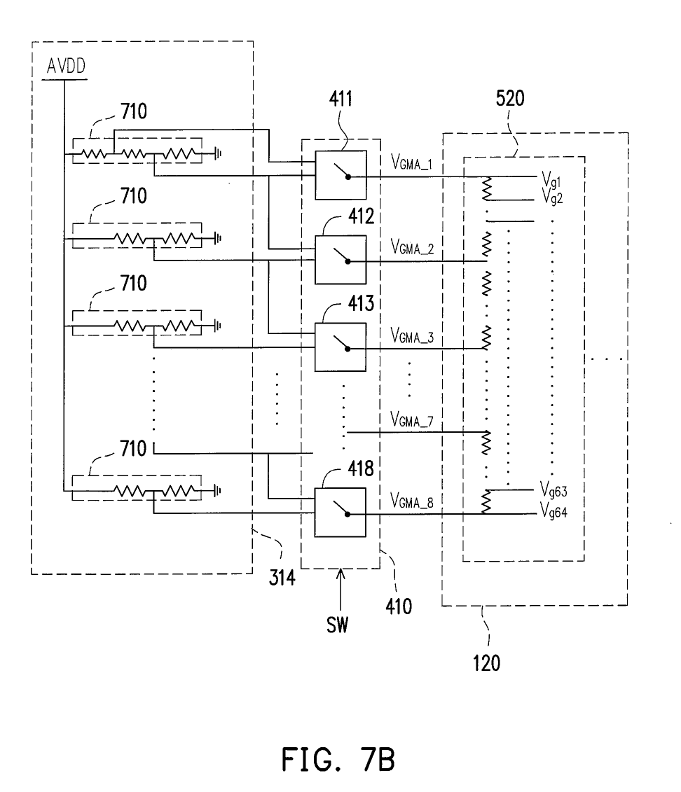

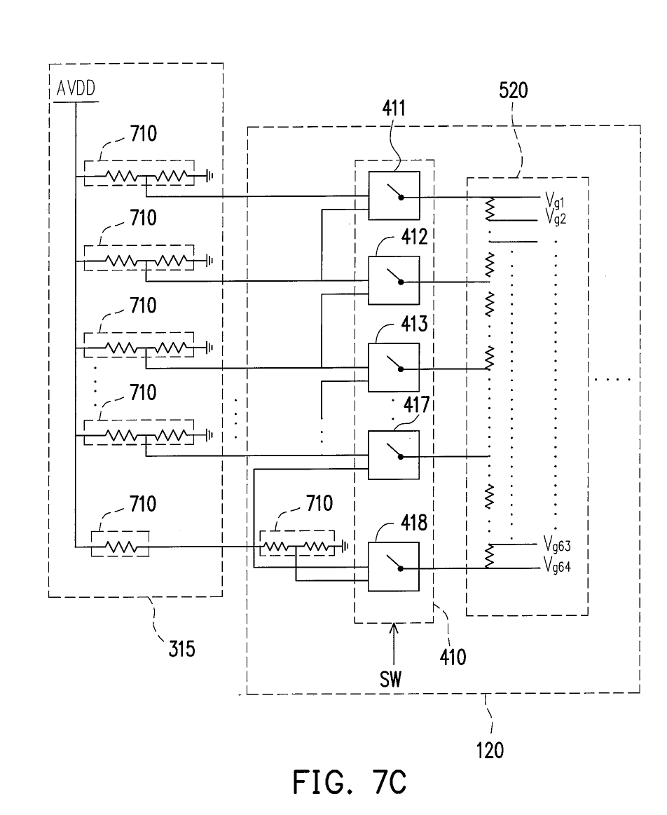

Those of ordinary skill in the art may modify the present invention according to the spirit embodied in the embodiments as disclosed above, which shall also be construed to be within the scope of the present invention. FIGS. 7A through 7C are schematic diagrams illustrating a gamma reference voltage generating device and a gray level voltage generating device according to a fifth embodiment of the present invention. The structure of the fifth embodiment is similar to that of the foregoing embodiments, except for the gamma reference voltage sources 313 through 315 of FIGS. 7A through 7C respectively include a plurality of serially connected resistor units 710 are connected in parallel for respectively providing different gamma reference voltages. In more details, each serially connected resistor unit 710 comprises a group of resistors having different number of serially connected resistors or serially connected resistors having different values so as to provide different gamma reference voltages. Similar function can also be achieved by the fourth embodiment.

All above embodiments are exemplified using LCDs. However, in other embodiments, the spirit of the present invention may also be applied to different types of displays, such as organic light emitting diode (OLED) displays, or thin film transistor liquid crystal display (TFT LCD).

In summary, the present invention receives M gamma reference voltages, and then selects N gamma reference voltages from the M gamma reference voltages, wherein M and N are positive integers, and M>N. In such a way, the gamma curves can be adaptively adjusted. Furthermore, the present invention has the following advantages:

1. By utilizing one switching signal controlling all switches of the selection unit, the control complexity can be simplified and the gamma curve may be rapidly adjusted.

2. By utilizing a plurality of switching signals to respectively control the switches in the selection unit, the gamma curve may be more flexibly adjusted.

3. By utilizing a plurality of switches for selecting different gamma reference voltages, and fixing a part of the gamma reference voltages, a section of the gamma curve may be flexibly adjusted.

4. The gamma reference voltage source utilizes a set of serially connected resistor units for providing a plurality of different gamma reference voltages, and therefore circuit area utilization may be reduced and hardware cost may also be reduced.

5. As the system voltage is fixed, the selection unit may be employed to switch different gamma reference voltages adjust the gamma curve, and therefore the risk of causing voltage deviation due to a changed system voltage may be reduced.

6. More variability of the gamma curve can be obtained by employing more input ends of the switch.

7. More gamma reference voltages can be obtained for the selection unit to select by employing more resistors of the serially connected resistor unit, and thus the variability of the gamma curve may be improved.

8. More variability of the gamma curve can be obtained by employing more number of switches.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A gray level voltage generating device, suitable for a display device for displaying a plurality of gray levels, comprising:
a selection unit, for receiving M first gamma reference voltages, and selecting N second gamma reference voltages from the M first gamma reference voltages and outputting the N second gamma reference voltages, wherein M and N are positive integers, and M>N; and
a gray level voltage generator, coupled to the selection unit, for generating a plurality of gray level voltages according to the N second gamma reference voltages, wherein the display device displays the gray levels according to the gray level voltages.

2. The gray level voltage generating device according to claim 1, wherein the selection unit comprises N switches defined respectively in sequence as first switch, second switch, . . . , and N^{th} switch, wherein each of the switches comprises P input ends, a control end, and an output end, and the P input ends are numbered in sequence as first input end, second input end, . . . , and P^{th} input end, wherein the control ends of the switches receive a switching signal, and each of the switches respectively selects one of the input ends to output to the output end according to the switching signal, wherein P is a positive integer.

3. The gray level voltage generating device according to claim 1 further comprising a voltage dividing resistor unit, coupled to a voltage source, wherein the voltage dividing resistor unit comprises a plurality of voltage dividing points for providing the first gamma reference voltages respectively.

4. The gray level voltage generating device according to claim 3, wherein the voltage dividing resistor unit comprises a serially connected resistor unit coupled to the voltage source to provide the first gamma reference voltages.

5. The gray level voltage generating device according to claim 3, wherein the voltage dividing resistor unit comprises a plurality of serially connected resistor units connected in parallel to the voltage source to provide the first gamma reference voltages, wherein the first gamma reference voltages are different from one another.

6. A gamma reference voltage generating device, coupled to a source driver, comprising:
a gamma reference voltage source, for providing M first gamma reference voltages; and
a selection unit, coupled to the gamma reference voltage source, for selecting N second gamma reference voltages from the M first gamma reference voltages and outputting the N second gamma reference voltages to the source driver, wherein M and N are positive integers, and M>N.

7. The gamma reference voltage generating device according to claim 6, wherein the selection unit comprises N switches defined respectively in sequence as first switch, second switch, . . . , and N^{th} switch, wherein each of the switches comprises P input ends, a control end, and an output end, and the P input ends are numbered in sequence as first input end, second input end, . . . , and P^{th} input end, wherein the control ends of the switches receive a switching signal, and each of the switches respectively selects one of the input ends to output to the output end according to the switching signal, wherein P is a positive integer.

8. The gamma reference voltage generating device according to claim 6 comprising a voltage dividing resistor unit coupled to a voltage source, wherein the voltage dividing resistor unit comprises a plurality of voltage dividing points for providing the first gamma reference voltages respectively.

9. The gamma reference voltage generating device according to claim 8, wherein the voltage dividing resistor unit comprises a serially connected resistor unit coupled to the voltage source to provide the first gamma reference voltages.

10. The gamma reference voltage generating device according to claim 8, wherein the voltage dividing resistor unit comprises a plurality of serially connected resistor units connected in parallel to the voltage source for providing the first gamma reference voltages, wherein the first gamma reference voltages are different from one another.

11. A gamma reference voltage generating device comprising:
a voltage dividing resistor unit, coupled to a voltage source, comprising a first voltage dividing point and a second voltage dividing point for providing a first gamma reference voltage and a second gamma reference voltage respectively; and
a selection unit comprising:
a first switch, coupled to the first voltage dividing point and the second voltage dividing point, for receiving the first gamma reference voltage and the second gamma reference voltage respectively, and selecting one from the received first gamma reference voltage and second gamma reference voltage to output according to a selection signal.

12. The gamma reference voltage generating device according to claim 11, wherein the voltage dividing unit further comprises a third voltage dividing point for providing a third gamma reference voltage.

13. The gamma reference voltage generating device according to claim 12, wherein the first switch is coupled to the third voltage dividing point for receiving the third gamma reference voltage.

14. The gamma reference voltage generating device according to claim 12, wherein the selection unit comprises a second switch coupled to the second voltage dividing point and the third voltage dividing point for receiving the second gamma reference voltage and the third gamma reference voltage, respectively, and selecting one from the gamma reference voltages received by the second switch to output according to the selection signal.

15. The gamma reference voltage generating device according to claim 14, wherein when the first switch outputs the first gamma reference voltage, the second switch outputs the second gamma reference voltage, and when the first switch outputs the second gamma reference voltage, the second switch outputs the third gamma reference voltage.

16. The gamma reference voltage generating device according to claim 12, wherein the voltage dividing resistor unit comprises a fourth voltage dividing point for providing a fourth gamma reference voltage.

17. The gamma reference voltage generating device according to claim 16, wherein the selection unit comprises a third switch coupled to the third voltage dividing point and the fourth voltage dividing point for receiving the third gamma reference voltage and the fourth gamma reference voltage respectively, and selecting one from the gamma reference voltages received by the third switch to output according to a selection signal.

18. The gamma reference voltage generating device according to claim 16, wherein the first switch is coupled to the third voltage dividing point for receiving the third gamma reference voltage.

19. The gamma reference voltage generating device according to claim 18, wherein the selection unit comprises a fourth switch coupled to the second voltage dividing point, the third voltage dividing point and the fourth voltage dividing point for receiving the second gamma reference voltage, the third gamma reference voltage, and the fourth gamma reference voltage, respectively, and selecting one from the gamma reference voltages received by the fourth switch to output according to a selection signal.

20. The gamma reference voltage generating device according to claim 19, wherein when the first switch outputs the first gamma reference voltage, the fourth switch outputs the second gamma reference voltage; when the first switch outputs the second gamma reference voltage, the fourth switch outputs the third gamma reference voltage; and when the first switch outputs the third gamma reference voltage, the fourth switch outputs the fourth gamma reference voltage.

21. The gamma reference voltage generating device according to claim 11, wherein the voltage dividing resistor unit comprises a serially connected resistor unit coupled to the voltage source to provide the first gamma reference voltages.

22. The gamma reference voltage generating device according to claim 11, wherein the voltage dividing resistor unit comprises a plurality of serially connected resistor units connected in parallel to the voltage source for providing the first gamma reference voltages, wherein the first gamma reference voltages are different from one another.

23. A method for generating gamma reference voltages, comprising:
receiving M gamma reference voltages, wherein M is a positive integer;
selecting N gamma reference voltages from the M gamma reference voltages to configure a first gamma reference curve when a first switch signal is received, and outputting the N gamma reference voltages; and
selecting N gamma reference voltages from the M gamma reference voltages to configure a second gamma reference curve when a second switch signal is received, and outputting the N gamma reference voltages, wherein N is a positive integer, wherein M>N, and wherein the first gamma curve is different from the second gamma curve.
